(19) United States
(12) Patent Application Publication
(10) Pub. No.: US 2010/0238335 A1
(43) Pub. Date: Sep. 23, 2010

(54) CLAMP CIRCUIT AND SOLID-STATE IMAGE SENSING DEVICE HAVING THE SAME

(76) Inventor: Satoshi SAKURAI, Kawasaki-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/723,901

(22) Filed: Mar. 15, 2010

(30) Foreign Application Priority Data
Mar. 18, 2009 (JP) 2009-067005

(51) Int. Cl. H04N 5/335; H03L 5/00

(52) U.S. Cl. 348/308; 327/328

(57) ABSTRACT

A clamp circuit includes a clamp circuit which limits an output of a source follower circuit, includes a first Nch transistor, a first constant current source connected between ground and the output terminal, a second Nch transistor having a gate that receives a bias voltage and a source connected to the output terminal of the source follower circuit, a second constant current source connected between the power supply and a drain of the second Nch transistor, and a first Pch transistor having a gate connected to the drain of the second Nch transistor, a source connected to the power supply, and a drain connected to the output terminal of the source follower circuit.

### CROSS-REFERENCE TO RELATED APPLICATIONS

This application is based upon and claims the benefit of priority from prior Japanese Patent Application No. 2009-067005, filed Mar. 18, 2009, the entire contents of which are incorporated herein by reference.

### BACKGROUND OF THE INVENTION

1. Field of the Invention

The present invention relates to a clamp circuit and a solid-state image sensing device having the same and, for example, to a clamp circuit configured to limit the output amplitude of a source follower circuit used in, e.g., the pixel amplifier of a solid-state image sensing device.

2. Description of the Related Art

Conventionally, a source follower circuit is generally used to detect a pixel signal (charges) in a CMOS image sensor serving as a solid-state image sensing device. Normally, in the pixel signal detection operation using the source follower circuit, incidence of extremely strong light such as sunlight leads to saturation of the output from a photodiode (PD). For this reason, charges sometimes leak to the detection unit (N1 node/FD) in the reset signal read operation so as to fix the output (reset signal) from the source follower circuit to the ground potential. In the pixel signal detection operation as well, the output (pixel signal) from the source follower circuit is fixed to the ground potential, and therefore, the difference between the reset signal and the pixel signal is zero. An A/D conversion unit at the succeeding stage erroneously recognizes this state as a no light state (black level).

To avoid this, a clamp circuit is added to limit the output amplitude of the source follower circuit in reset signal reading. The clamp circuit configured to limit the output amplitude of the source follower circuit can have various arrangements. A typical example is known to use an operational amplifier. The operational amplifier compares the source follower output with a reference bias voltage, thereby controlling the source follower output.

### BRIEF SUMMARY OF THE INVENTION

A clamp circuit according to an aspect of the present invention comprising a clamp circuit which limits an output of a source follower circuit, comprising: a first Nch transistor having a gate that receives an input voltage, a drain connected to a power supply, and a source connected to an output terminal; a first constant current source connected between ground and the output terminal; a second Nch transistor having a gate that receives a bias voltage and a source connected to the output terminal of the source follower circuit; a second constant current source connected between the power supply and a drain of the second Nch transistor; and a first Pch transistor having a gate connected to the drain of the second Nch transistor, a source connected to the power supply, and a drain connected to the output terminal of the source follower circuit.

A solid-state image sensing device according to an aspect of the present invention comprising a solid-state image sensing device comprising: a plurality of pixel cells arranged in a matrix, each pixel cell having at least a reset transistor and an amplification transistor; a plurality of source follower circuits formed by connecting bias transistors arrayed in a row direction and the amplification transistors in a predetermined pixel cells arranged in each column direction; and a plurality of clamp circuits of claim 1 which are arrayed in the row direction and connected to outputs of the plurality of source follower circuits.

### BRIEF DESCRIPTION OF THE SEVERAL VIEWS OF THE DRAWING

FIG. 1 is a block diagram showing an example of the arrangement of a solid-state image sensing device (CMOS image sensor) according to the first embodiment of the present invention;

FIG. 2 is a circuit diagram showing an example of the arrangement of a sensor core unit of the CMOS image sensor according to the first embodiment;

FIG. 3 is a circuit diagram showing an example of the arrangement of an output clamp circuit for a source follower circuit of the CMOS image sensor according to the first embodiment;

FIG. 4 is a circuit diagram showing an example of the arrangement of an output clamp circuit for a source follower circuit of a CMOS image sensor according to the second embodiment of the present invention; and

FIG. 5 is a circuit diagram showing an example of the arrangement of an output clamp circuit for a source follower circuit of a CMOS image sensor according to the third embodiment of the present invention.

### DETAILED DESCRIPTION OF THE INVENTION

In the above-described arrangement in which an operational amplifier compares a source follower output with a reference bias voltage to control the source follower output, the clamp circuit using the operational amplifier always needs a steady current. For this reason, the circuit tends to be inappropriate for a requirement of low power consumption.

In addition, a method has been proposed, which causes a comparator to monitor the output from a source follower circuit in the reset signal read operation, thereby controlling circuits at the succeeding stages including an A/D conversion unit (e.g., U.S. Pat. No. 6,803,958).

In the above U.S. patent reference, however, many circuits such as comparators and control circuits need to be added. Especially, in a sensor of parallel read scheme in a micropixel, these circuits need to be added for each column. This increases the overall area.

The embodiments of the present invention will be described below in detail with reference to the accompanying drawing. Note that the drawing is in schematic form, and the dimensions and ratios in the drawing are different from actual dimensions and ratios. The views also include parts where the dimensional relationship and/or the ratio is different as a matter of course. Especially, several embodiments to be explained below exemplify an apparatus and method for embodying the technical concept of the present invention, and the technical concept of the present invention is not specified by the shapes, structures, and layouts of the constituent elements. Various changes and modifications can be made for the technical concept of the present invention without departing from the scope of the invention.

### First Embodiment

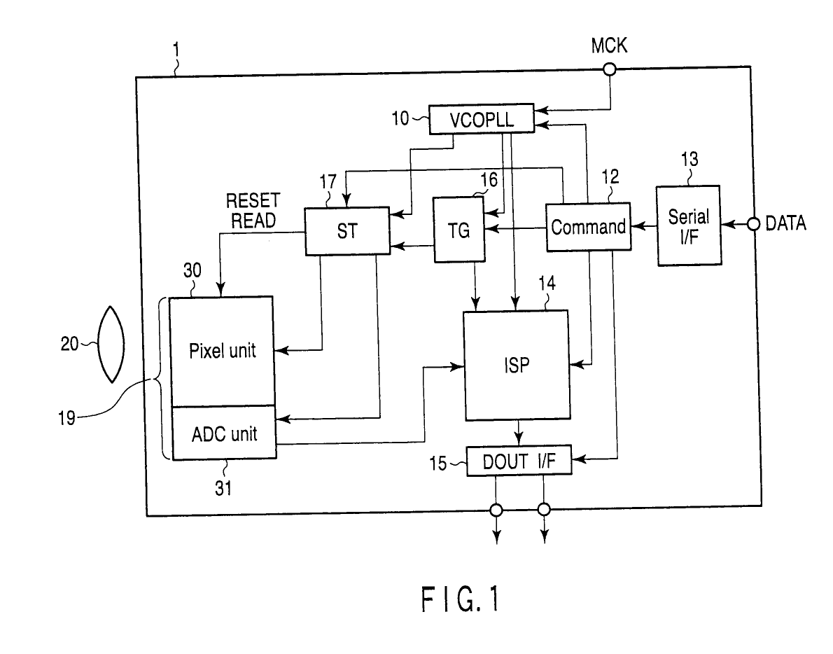

FIG. 1 shows an example of the arrangement of a solid-state image sensing device according to the first embodiment of the present invention. Note that a CMOS image sensor of parallel read scheme will be exemplified here.

As shown in FIG. 1, a CMOS image sensor 1 comprises a clock control circuit (to be referred to as a VCOPLL hereinafter) 10, serial command input/output unit 12, serial interface (to be referred to as a serial I/F hereinafter) 13, video signal processing circuit (to be referred to as an ISP hereinafter) 14, data output interface (to be referred to as a DOUT I/F hereinafter) 15, reference timing generation circuit (to be referred to as a TG hereinafter) 16, sensor driving timing generation circuit (to be referred to as an ST hereinafter) 17, sensor core unit 19, and lens 20. The sensor core unit 19 comprises a pixel unit 30, and an A/D conversion circuit unit (to be referred to as an ADC unit hereinafter) 31 provided near the pixel unit 30.

Each unit will be described below in detail. The VCOPLL 10 generates an internal clock (clock signal CLK) of the CMOS image sensor 1 based on a master clock MCK. The generated clock signal CLK is output to the TG 16, ISP 14, and ST 17. The master clock MCK is a clock signal obtained based on a clock (external clock) provided outside the CMOS image sensor 1. Note that the VCOPLL 10 controls the frequency of the internal clock CLK.

The serial I/F 13 receives, from the outside, control data DATA to operate the system of the entire CMOS image sensor including the ISP 14. The control data DATA is, for example, a command or an operation timing signal to operate the whole sensor. The serial I/F 13 supplies the control data DATA received from the outside to the serial command input/output unit 12.

The serial command input/output unit 12 outputs the control data DATA received from the serial I/F 13 to the VCOPLL 10, ISP 14, DOUT I/F 15, TG 16, and ST 17.

Based on the clock signal CLK and the control data DATA supplied from the serial command input/output unit 12, the TG 16 outputs instructions to the ST 17 and the ISP 14 to control the operations of the sensor core unit 19 and the ISP 14. That is, the TG 16 instructs the operation timing of the ISP 14 which performs video signal processing and that of the ST 17 which controls the operation timing of the sensor core unit 19. For example, the TG 16 outputs, to the ST 17, instructions of a timing of reading charges after accumulation of charges (pixel signal) received by the sensor core unit 19, a timing of A/D-converting the read charges into a video signal, a timing of transferring the video signal to the ISP 14, and the like. Simultaneously, the TG 16 supplies, to the ISP 14, instructions of a timing of video signal transfer from the sensor core unit 19, a timing of outputting the video signal to the DOUT I/F 15, and the like.

In accordance with the operation timing instruction received from the TG 16, the ST 17 supplies a detection unit reset pulse (to be referred to as a signal RESETm hereinafter) and a signal read pulse (to be referred to as a signal READm hereinafter) to the sensor core unit 19. Note that the signals RESETm and READm are digital signals that can take, for example, one of “L (Low)” level and “H (High)” level. The ST 17 supplies an instruction of an operation timing necessary for the sensor core unit 19.

The sensor core unit 19 includes the pixel unit 30 which comprises a plurality of pixels (to be referred to as pixels 40 hereinafter) arranged in a matrix. More specifically, based on the signals RESETm and READm supplied from the ST 17, the pixel unit 30 performs the reset operation of the plurality of pixels 40 arranged in a matrix and the charge detection operation of the pixels 40. Note that upon the reset operation, the pixel unit 30 supplies a reset signal of reset level (reset voltage) to the ADC unit 31 via a clamp circuit to be described later.

In accordance with the operation timing instruction supplied from the ST 17, the ADC unit 31 A/D (Analog-to-Digital) converts the analog reset signal and pixel signal supplied from the pixel unit 30, and outputs the difference between the digital signals. At this time, the ADC unit 31 converts the analog reset signal and pixel signal into digital values of, for example, 1,024 levels. As a result, the ADC unit 31 obtains, for example, a 10-bit digital video signal. After that, the obtained digital video signal is read out from the ADC unit 31 to the ISP 14.

Based on the operation timing instruction supplied from the TG 16, the ISP 14 executes, for the digital video signal received from the sensor core unit 19, video signal processing such as white balance processing, wide dynamic range processing, noise reduction processing, and defective pixel correction processing. The ISP 14 outputs, to the DOUT I/F 15, the digital video signal that has undergone the video signal processing.

The DOUT I/F 15 outputs the digital video signal that has undergone the video signal processing by the ISP 14 to the outside of the CMOS image sensor 1.

The lens 20 condenses external light, passes it through a separation filter (not shown), and supplies the light to the pixel unit 30. Note that the filter separates the light into R, G, and B components. Circuit Arrangement of Sensor Core Unit 19

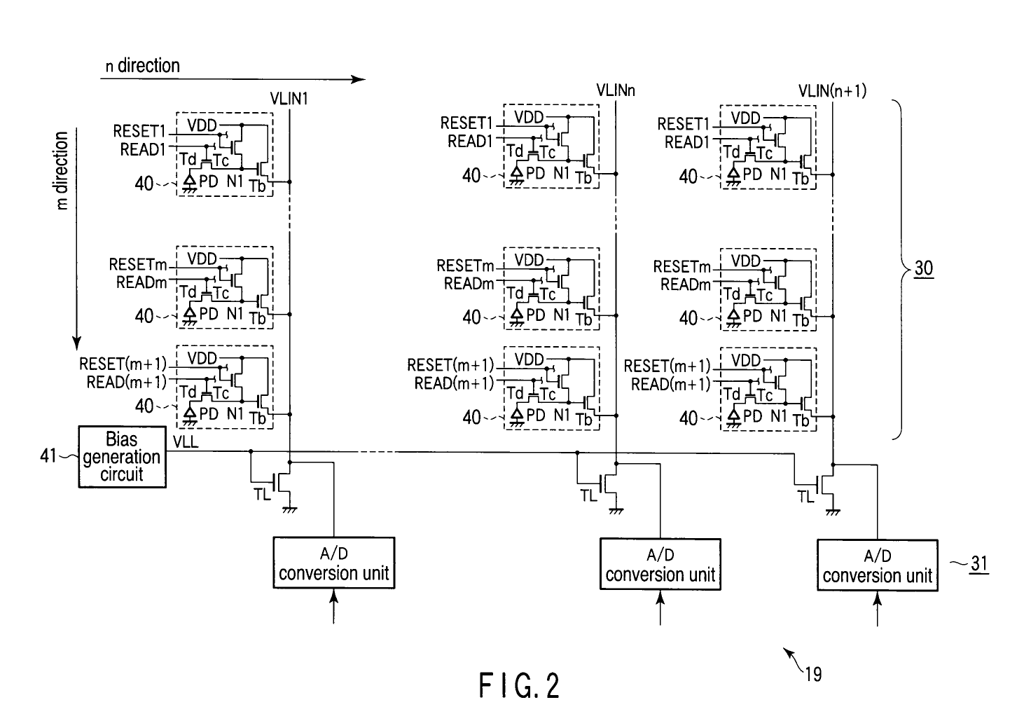

Details of the sensor core unit 19 will be explained next. FIG. 2 shows an example of the circuit arrangement of the sensor core unit 19.

As shown in FIG. 2, the pixel unit 30 includes a predetermined number of (in this example, m+1) pixels 40 provided in the vertical (m) direction and connected to each of a plurality of vertical signal lines VLINn. That is, the pixel unit 30 comprises the plurality of pixels 40 arranged in a matrix. A bias MOS transistor TL and an A/D conversion unit of the ADC unit 31 are connected to each of the vertical signal lines VLINn.

Note that out of the pixels 40 arranged on the first line in the horizontal (n) direction perpendicular to the vertical signal lines VLINn, the pixel 40 connected to a vertical signal line VLIN1 will be exemplified below.

The pixel 40 comprises MOS transistors Tb, Tc, and Td and a photodiode PD. The gate of the MOS transistor Tc receives a signal RESET1 supplied from the ST 17. The drain terminal receives a voltage VDD (for example, 2.8 V). The source terminal is connected to a connection node N1. That is, the MOS transistor Tc functions as a reset transistor which generates a reset voltage serving as the reference voltage of the pixel signal read from the photodiode PD.

The gate of the MOS transistor Td receives a signal READ1 supplied from the ST 17. The drain terminal is connected to the connection node N1. The source terminal is connected to the cathode of the photodiode PD. That is, the MOS transistor Td functions as a signal charge read transistor. Note that the anode of the photodiode PD is grounded.

The gate of the MOS transistor Tb is connected to the connection node N1. The drain terminal receives the voltage VDD. The source terminal is connected to the vertical signal line VLIN1. That is, the MOS transistor Tb functions as an amplification transistor which amplifies a pixel signal.

In short, the gate of the MOS transistor Tb, the source terminal of the MOS transistor Tc, and the drain terminal of the MOS transistor Td are commonly connected to the connection node N1. The connection node N1 serves as a node (detection unit FD) which detects the potential (charges).

The signal lines to transmit the signals RESET1 and READ1, respectively, are commonly connected to the pixels 40 arranged on the first line in the horizontal direction perpendicular to the vertical signal lines VLINn. More specifically, the signal lines are first lines in the horizontal direction perpendicular to the vertical signal lines VLINn and are commonly connected to the pixels 40 connected to the vertical signal lines VLINn (VLIN1 to VLIN(n+1)). Note that this also applies to the second to (m+1)th lines in the horizontal direction perpendicular to the vertical signal lines VLINn.

The pixels 40 arranged on the same column are commonly connected to one of the vertical signal lines VLIN1 to VLIN(n+1) via the source terminals of the MOS transistors Tb. The vertical signal lines VLIN1 to VLIN(n+1) will be simply referred to as the vertical signal lines VLINn without discrimination, where n is a natural number of 1 or more.

One of signals RESET1 to RESET(m+1) and one of signals READ1 to READ(m+1) are commonly supplied to the pixels 40 arranged on the same row (line). The signals RESET1 to RESET(m+1) and the signals READ1 to READ(m+1) will also be simply referred to as the signals RESETm and signals READm without discrimination, where m is a natural number of 1 or more.

The drain of the MOS transistor TL is connected to one end of the vertical signal line VLINn. The gate receives a voltage VLL generated by a voltage generation circuit (bias generation circuit) 41. The source terminal is grounded. Note that the voltage VLL output from the voltage generation circuit 41 is supplied to the gates of all MOS transistors TL corresponding to the vertical signal lines VLIN1 to VLIN(n+1). The MOS transistors TL and Tb form a source follower circuit (pixel amplifier).

The basic operation of the CMOS image sensor 1 having the above-described arrangement will be described next. The CMOS image sensor 1 performs the reset signal read operation and the pixel signal detection operation parallelly for the “rows” of the plurality of pixels 40 arranged in a matrix. The A/D conversion unit arranged for each “column” converts the difference between the reset signal and the pixel signal into a digital value, thereby obtaining a digital video signal corresponding to an object image.

In the pixel 40, first, the signal RESETm and the signal READm are turned on simultaneously to reset the photodiode PD. The signal RESETm and the signal READm are then turned off. After a predetermined charge accumulation time, the signal RESETm is turned on/off again to reset the connection node N1 to the voltage VDD. The connection node N1 serves as the input of the source follower circuit formed from the MOS transistor Tb and the MOS transistor TL connected to the vertical signal line VLINn. At this time, the source follower circuit outputs an analog reset signal. After that, the signal READm is turned on/off to read out charges obtained by photoelectric conversion of the photodiode PD and accumulated in it to the connection node N1. At this time, the source follower circuit outputs an analog pixel signal. The difference between the reset signal and the pixel signal is proportional to the amount of light incident on the photodiode PD. Hence, the A/D conversion unit at the succeeding stage calculates the difference. The ADC unit 31 thus obtains the digital signal difference of each column so as to finally obtain a digital video signal. Example of Arrangement of Output Clamp Circuit for Source Follower Circuit

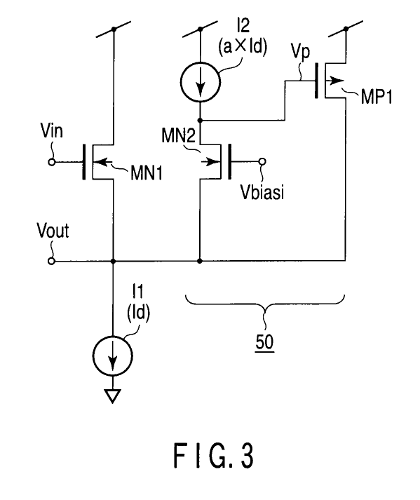

FIG. 3 shows an example of the arrangement of an output clamp circuit for a source follower circuit. A clamp circuit 50 is configured to prevent the output (reset signal) from the source follower circuit from being fixed to the ground potential at the time of reset signal read operation without using an operational amplifier.

Assume that the source follower circuit includes an N-channel MOS transistor (first transistor of first conductivity type) MN1 whose gate receives a voltage (input voltage) Vin, and a constant current source (first constant current source) I1 that flows a current Id, and connects the node between the MOS transistor MN1 and the constant current source I1 to an output terminal Vout. In this case, the clamp circuit 50 includes a voltage detection N-channel MOS transistor (second transistor of first conductivity type) MN2 whose gate receives a bias voltage Vbiasi, a constant current source (second constant current source) I2 that flows a current a×Id (a<1), and a P-channel MOS transistor (first transistor of second conductivity type) MP1. The clamp circuit 50 is arranged in correspondence with each A/D conversion unit. That is, the clamp circuits are arrayed in the row direction of the pixel unit 30.

In each clamp circuit 50, the drain of the MOS transistor MN1 is connected to the power supply, and the source is connected to the output terminal Vout. The constant current source I1 is connected between the output terminal Vout and ground. The constant current source I2 is connected between the power supply, the drain of the MOS transistor MN2, and the gate of the MOS transistor MP1. The source of the MOS transistor MN2 is connected to the output terminal Vout. The source of the MOS transistor MP1 is connected to the power supply, and the drain is connected to the output terminal Vout.

If Vin>>Vbiasi, the voltage (output voltage) that appears at the output terminal Vout changes in accordance with

Vout=Vin−Vth1−{square root over ((2·Id/(μ·Cox)·L1/W1))} (1)

where Vth1 is the threshold voltage of the N-channel MOS transistor MN1, Id is the current of the constant current source I1, μ is the mobility of the N-channel MOS transistor MN1, Cox is the gate capacitance of the N-channel MOS transistor MN1, W1 is the gate width of zthe N-channel MOS transistor MN1, and L1 is the gate length of the N-channel MOS transistor MN1.

When the voltage Vin becomes lower and closer to the bias voltage Vbiasi, a current starts flowing to the voltage detection MOS transistor MN2, and a voltage Vp that is the gate input of the MOS transistor MP1 is pulled down toward the ground potential. At this time, since the constant current source I2 includes a P-channel MOS transistor and the like, the smaller the current a×Id becomes, the higher the impedance becomes, and the more easily the voltage Vp is pulled down to the ground side. When the voltage Vp has lowered, the MOS transistor MP1 whose gate receives the voltage Vp flows a current to maintain the output terminal Vout at a predetermined voltage (clamp voltage) or more. This implements a clamp operation.

On the other hand, if Vin<<Vbiasi, the voltage that appears at the output terminal Vout is clamped in accordance with

Vout=Vbiasi−Vth2−{square root over ((2·a·Id/(μ·Cox)·L2/W2))} (4

where Vth2 is the threshold voltage of the N-channel MOS transistor MN2, a·Id is the current of the constant current source I2 (a is the current ratio of the constant current sources I1 and I2), μ is the mobility of the N-channel MOS transistor MN2, Cox is the gate capacitance of the N-channel MOS transistor MN2, W2 is the gate width of the N-channel MOS transistor MN2, and L2 is the gate length of the N-channel MOS transistor MN2.

Hence, when the clamp circuit 50 is connected to the source follower circuit formed from the bias MOS transistor TL (corresponding to the constant current source I1) and the amplifier transistor Tb (corresponding to the N-channel MOS transistor MN1) of the pixel unit 30, the output amplitude of the source follower circuit can easily be limited. More specifically, even when the charges from the photodiode PD leak to the connection node N1 in the reset signal read operation, the clamp circuit 50 can prevent the output from the source follower circuit from being fixed to the ground potential. Hence, even when extremely strong light such as sunlight becomes incident on the photodiode PD to cause saturation of the output from the photodiode PD, it is possible to prevent the ADC unit 31 from erroneously recognizing the state as black level.

The clamp circuit 50 can realize a high-sensitivity clamp characteristic without requiring additional current consumption by using the current distribution characteristic of the differential pair including the MOS transistors MN1 and MN2. The clamp circuit is suitable for an application purpose in low current consumption because the current is always maintained at the current Id of the source follower circuit independently of whether the clamp operation is being performed or not. That is, the circuit can reduce the current consumption, the number of additional circuits (elements), and the area, as compared to the clamp circuit using an operational amplifier or the method that needs an additional circuit such as a comparator.

The clamp circuit 50 of this embodiment can freely control the clamp voltage and detection sensitivity by changing the bias voltage Vbiasi, the current ratio a of the constant current source I1 and I2, and the W/L ratios of the N-channel MOS transistors MN1 and MN2.

As described above, the clamp circuit is formed without requiring either an operational amplifier or an additional circuit such as a comparator. In the reset signal read operation and/or the pixel signal detection operation, the output voltage from the source follower circuit is prevented from lowering to a predetermined voltage or less. More specifically, even when the input voltage of the source follower circuit has lowered, the clamp circuit performs the clamp operation using the current distribution characteristic of the differential pair of the transistors not to make the output voltage from the source follower circuit lower to a predetermined voltage or less. This allows to implement a high-sensitivity clamp characteristic without requiring additional current consumption. It is therefore possible to reduce the current consumption and area of the clamp circuit. In addition, applying the clamp circuit to limit the output amplitude of the source follower circuit used in, e.g., the pixel amplifier of a CMOS image sensor of parallel read scheme enables to avoid erroneous pixel signal level recognition caused by, for example, saturation of the photodiode.

### Second Embodiment

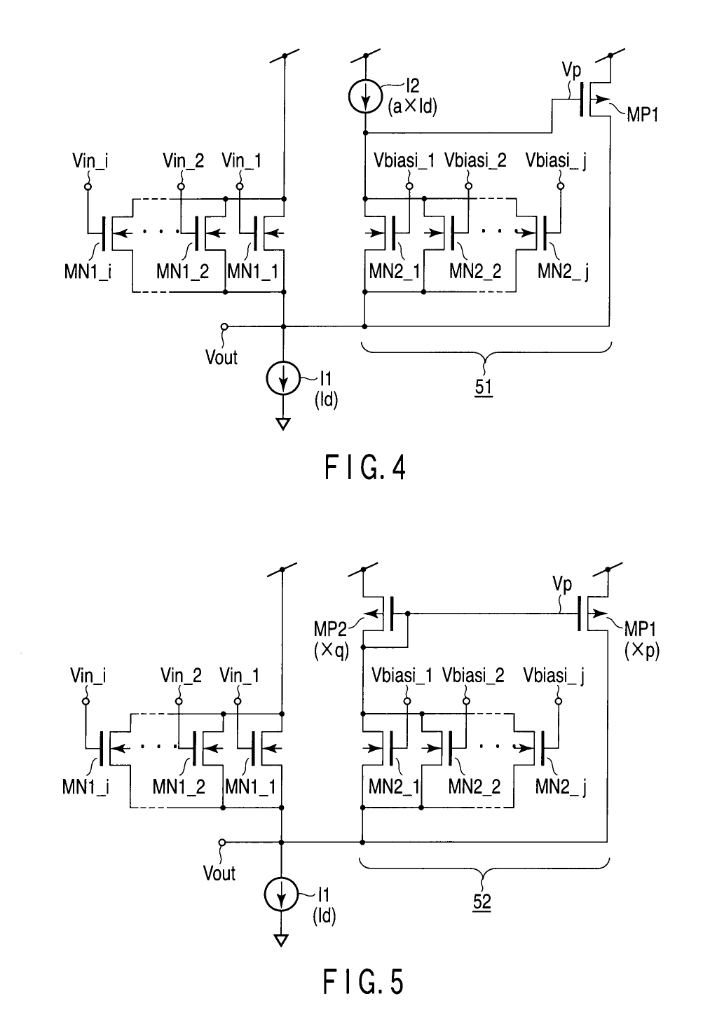

FIG. 4 shows an example of the arrangement of a clamp circuit according to the second embodiment of the present invention. An output clamp circuit for a source follower circuit used in a CMOS image sensor of parallel read scheme will be exemplified here. Note that the same reference numerals as in the first embodiment denote the same parts in FIG. 4, and a detailed description thereof will be omitted.

The clamp circuit of this embodiment is different from the clamp circuit 50 of the first embodiment in that the input of the source follower circuit is formed from N-channel MOS transistors MN1_1, MN1_2, . . . , MN1_i of i (i is a natural number of 1 or more) stages, and the input of a clamp circuit 51 is formed from voltage detection N-channel MOS transistors MN2_1, MN2_2, . . . , MN2_j of j (j is a natural number of 1 or more) stages. The N-channel MOS transistors MN1_1, MN1_2, . . . , MN1_i and the voltage detection N-channel MOS transistors MN2_1, MN2_2, . . . , MN2_j are connected in parallel.

When the source follower circuit is operating, the voltage that appears at an output terminal Vout is proportional to the average value of voltages Vin_1, Vin_2, . . . , Vin_i input to the gates of the MOS transistors MN1_1, MN1_2, . . . , MN1_i. That is, even when an input voltage Vin of the source follower circuit has lowered, its output voltage (Vout) can be prevented from lowering to a predetermined voltage or less. Hence, applying the clamp circuit 51 to limit the output amplitude of the source follower circuit used in, e.g., the pixel amplifier of a CMOS image sensor 1 enables to prevent the output voltage of the source follower circuit from lowering to a predetermined voltage or less in the reset signal read operation and/or the pixel signal detection operation.

The clamp circuit 51 of this embodiment can freely control the clamp voltage and detection sensitivity in, e.g., the clamp operation by setting bias voltages Vbiasi_1, Vbiasi_2, . . . , Vbiasi_j that are input to the gates of the MOS transistors MN2_1, MN2_2, . . . , MN2_j to different values to perform an averaging operation or by setting the plurality of bias voltages to a single value and other terminals at the ground potential to perform an off operation.

In this embodiment, the clamp voltage and detection sensitivity can also be controlled by connecting switches (not shown) in series to the MOS transistors MN1_1, MN1_2, . . . , MN1_1 and the MOS transistors MN2_1, MN2_2, . . . , MN2_j and on/off-controlling the switches.

Note that in this embodiment as well, the clamp circuit is suitable for an application purpose in low current consumption because the current is always maintained at a current Id of the source follower circuit, and no additional current is therefore necessary independently of whether the clamp operation is being performed or not. In addition, since the number of additional circuits can be small, the area can be reduced. Especially, applying the clamp circuit 51 to limit the output amplitude of the source follower circuit used in, e.g., the pixel amplifier of the CMOS image sensor 1 of parallel read scheme enables to avoid erroneous pixel signal level recognition caused by, for example, saturation of a photodiode PD.

### Third Embodiment

FIG. 5 shows an example of the arrangement of a clamp circuit according to the third embodiment of the present invention. An output clamp circuit for a source follower circuit used in a CMOS image sensor of parallel read scheme will be exemplified here. Note that the same reference numerals as in the second embodiment denote the same parts in FIG. 5, and a detailed description thereof will be omitted.

A clamp circuit 52 of this embodiment is different from the clamp circuit 51 of the second embodiment in that a diode-connected P-channel MOS transistor (second transistor of second conductivity type) MP2 replaces the constant current source O2, as shown in FIG. 5.

The clamp circuit 52 can implement a high-sensitivity clamp circuit by setting the dimension ratios (or the ratios of the numbers of transistors connected in parallel) of P-channel MOS transistors MP1 and MP2 to p>q, where p is the dimension ratio of the MOS transistor MP1, and q is the dimension ratio of the MOS transistor MP2.

In this arrangement as well, the clamp circuit is suitable for an application purpose in low current consumption because the current is always maintained at a current Id of the source follower circuit, and no additional current is therefore necessary independently of whether the clamp operation is being performed or not. In addition, since the number of additional circuits can be small, the area can be reduced. Especially, applying the clamp circuit 52 to limit the output amplitude of the source follower circuit used in, e.g., the pixel amplifier of a CMOS image sensor 1 of parallel read scheme enables to avoid erroneous pixel signal level recognition caused by, for example, saturation of a photodiode PD. That is, even when the input voltage of the source follower circuit has lowered in the reset signal read operation and/or the pixel signal detection operation, its output voltage can be prevented from lowering to a predetermined voltage or less.

Note that in each of the above embodiments, a source follower circuit having an N-channel structure has been exemplified. However, the present invention is not limited to this, and can be practiced in a source follower circuit having a P-channel structure as well.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A clamp circuit which limits an output of a source follower circuit, comprising:
a first Nch transistor having a gate that receives an input voltage, a drain connected to a power supply, and a source connected to an output terminal;
a first constant current source connected between ground and the output terminal;
a second Nch transistor having a gate that receives a bias voltage and a source connected to the output terminal of the source follower circuit;
a second constant current source connected between the power supply and a drain of the second Nch transistor; and
a first Pch transistor having a gate connected to the drain of the second Nch transistor, a source connected to the power supply, and a drain connected to the output terminal of the source follower circuit.

2. The circuit of claim 1, wherein the clamp circuit limits a voltage that appears at the output terminal so as to prevent the voltage from lowering to not more than a predetermined voltage when the input voltage has lowered.

3. The circuit of claim 1, wherein
the first Nch transistor is formed from a plurality of parallelly connected transistors of first conductivity type each having a gate that receives the input voltage, and
the second Nch transistor is formed from a plurality of parallelly connected transistors of first conductivity type each having a gate that receives the bias voltage.

4. The circuit of claim 1, wherein
the first Nch transistor is formed from a plurality of parallelly connected transistors of first conductivity type each having a gate that receives the input voltage,
the second Nch transistor is formed from a plurality of parallelly connected transistors of first conductivity type each having a gate that receives the bias voltage, and
the second constant current source is replaced with a second transistor of second conductivity type having a gate and drain connected to the drain of the second Nch transistor and the gate of the first Pch transistor, respectively, and a source connected to the power supply.

5. The circuit of claim 1, wherein
the first Nch transistor is replaced with an amplification transistor in each pixel cell of a solid-state image sensing device, and
the first constant current source is replaced with a bias transistor for a vertical signal line of the solid-state image sensing device.

6. The circuit of claim 1, wherein the clamp circuit is configured without using an operational amplifier for the source follower circuit.

7. The circuit of claim 6, wherein the clamp circuit is controlled to prevent the output of the source follower circuit from being fixed to a ground potential in a reset signal read operation.

8. A solid-state image sensing device comprising:
a plurality of pixel cells arranged in a matrix, each pixel cell having at least a reset transistor and an amplification transistor;
a plurality of source follower circuits formed by connecting bias transistors arrayed in a row direction and the amplification transistors in a predetermined pixel cells arranged in each column direction; and
a plurality of clamp circuits of claim 1 which are arrayed in the row direction and connected to outputs of the plurality of source follower circuits.

9. The device of claim 8, wherein the plurality of clamp circuits perform a clamp operation to prevent the outputs of the plurality of source follower circuits from lowering to not more than a predetermined voltage in one of a reset signal read operation and a pixel signal detection operation.

10. The device of claim 8, wherein
a first Nch transistor included in each of the plurality of clamp circuits is formed from a plurality of parallelly connected transistors of first conductivity type each having a gate that receives an input voltage, and
a second Nch transistor is formed from a plurality of parallelly connected transistors of first conductivity type each having a gate that receives a bias voltage.

11. The device of claim 8, wherein
a first Nch transistor included in each of the plurality of clamp circuits is formed from a plurality of parallelly connected transistors of first conductivity type each having a gate that receives an input voltage,
a second Nch transistor is formed from a plurality of parallelly connected transistors of first conductivity type each having a gate that receives a bias voltage, and
a second constant current source is replaced with a second transistor of second conductivity type having a gate and drain connected to a drain of the second Nch transistor and a gate of the first Pch transistor, respectively, and a source connected to a power supply.

12. The device of claim 8, wherein
the first Nch transistor included in each of the plurality of clamp circuits is replaced with the amplification transistor in each pixel cell of the solid-state image sensing device, and
the first constant current source is replaced with a bias transistor for a vertical signal line of the solid-state image sensing device.

13. The device of claim 8, wherein the clamp circuit is configured without using an operational amplifier for the source follower circuit.

14. The device of claim 13, wherein each of the plurality of clamp circuits is controlled to prevent the output of the source follower circuit from being fixed to a ground potential in the reset signal read operation.

15. The device of claim 8, further comprising a video signal processing circuit which performs, based on an operation timing instruction, video signal processing for a digital video signal supplied from each of the plurality of pixel cells.
